(19) United States
(12) Patent Application Publication
(10) Pub. No.: US 2016/0364083 A1
(43) Pub. Date: Dec. 15, 2016

(54) OPTICAL TOUCH SYSTEMS

(71) Applicant: Quanta Computer Inc., Taoyuan City (TW)

(72) Inventors: Yun-Cheng LIU, Taoyuan City (TW); Chien-Hung LIN, Taoyuan City (TW); Chung-Sheng WU, Taoyuan City (TW)

(21) Appl. No.: 14/828,855

(22) Filed: Aug. 18, 2015

(30) Foreign Application Priority Data
Jun. 12, 2015 (TW) 104119023

(51) Int. Cl. G06F 3/042; G06F 3/0354

(52) U.S. Cl. CPC G06F 3/0421; G06F 3/03545

(57) ABSTRACT

An optical touch system includes a screen, an image-erasing device, an image-sensing module, a processing unit, and an image processor. The image-erasing device includes a body and reflection portions on the body. The image-erasing device is detachably contacted with the screen. The image-sensing module includes a light source emitting a light beam to the reflection portions to respectively generate a reflected light beam, and an image sensor detecting the reflected light beams. The processing unit obtains positions on the screen respectively corresponding to the reflection portions according to the reflected light beams, and defines position information of an erasing region according to the positions on the screen. The image processor outputs a display image to be displayed on the screen, and erases data of the display image corresponding to the erasing region according to the position information.

### CROSS REFERENCE TO RELATED APPLICATIONS

This Application claims priority of Taiwan Patent Application No. 104119023, filed on Jun. 12, 2015, the entirety of which is incorporated by reference herein.

### BACKGROUND OF THE INVENTION

Field of the Invention

The invention relates generally to optical touch systems, more particularly to optical touch systems with image-erasing functions.

Description of the Related Art

Conventional electronic display systems display images by projection or on flat panel displays. Flat panel displays may comprise liquid-crystal displays (LCD), plasma display panel (PDP) displays, organic light-emitting diode (OLED) displays, field emission displays (FED) and light-emitting diode (LED) displays.

Recent electronic display systems comprise touch-control functionality. The touch control system may comprise a display and a stylus. The display may use a sensing device to sense the input signal provided by the stylus. The touch control system can be classified by type, such as resistance type, capacitance type, optical type, and so on. By combining an image display with touch-control functionality, electronic whiteboard products have been produced.

Conventional whiteboard software may comprise image-erase functions, such as the eraser function. When using the image-erase function, the user first has to select the image-erase function through the user interface, and then erase a predetermined region using a cursor. However, this complex method is completely different from the use of an actual whiteboard, causing it to be inconvenient for users. Thus, there is a need for an optical touch system with improved user experience in the implementation of image-erase functions.

### BRIEF SUMMARY OF THE INVENTION

For solving above problems, the invention provides an optical touch system with image-erasing functionality, with allow users to control the erasing region.

In an embodiment of an optical touch system includes a screen, an image-erasing device, an image-sensing module, a processing unit, and an image processor. The image-erasing device includes a body and reflection portions on the body. The image-erasing device is detachably contacted with the screen. The image-sensing module is adjacent to the screen, and respectively includes a light source emitting a light beam to the reflection portions to generate reflected light beams, and an image sensor detecting the reflected light beams. The processing unit obtains positions on the screen respectively corresponding to the reflection portions according to the reflected light beams, and defines the position information of an erasing region according to the positions on the screen respectively corresponding to the reflection portions. The image processor outputs a display image to be displayed on the screen, and erases data of the display image corresponding to the erasing region according to the position information.

An embodiment of an optical touch system includes a screen, a selection device, an image-erasing device, an image-sensing module, a processing unit and an image processor. The selection device includes a first reflection portion. The image-erasing device includes a body and second reflection portions on the body. The selection device and the image-erasing device are detachably contacted with the screen. The image-sensing module is adjacent to the screen, and includes a light source emitting a light beam to the first reflection portion or the second reflection portions to generate reflected light beams corresponding to the first reflection portion or the second reflection portions, and an image sensor detecting the reflected light beams. The processing unit obtains a first position on the screen corresponding to the first reflection portion or a plurality of second positions on the screen respectively corresponding to the second reflection portions according to the reflected light beams, obtains input position information according to the first position and executes a selection or input process according to the input position information when the first reflection portion is detected, and defines erasing position information of an erasing region according to the second positions when the second reflection portions are detected. The image processor outputs a display image to be displayed on the screen, displays a visual effect corresponding to the selection or input process on the screen according to the input position information, and erases data of the display image corresponding to the erasing region according to the erasing position information.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings. In addition, the present invention may repeat reference numerals and/or letters in the various examples, wherein:

FIG. 1 is a block diagram of an optical touch system according to an embodiment of the invention;

FIG. 2 illustrates the configuration of an optical touch system according to an embodiment of the invention;

FIG. 3 shows a side view illustrating that the selection device 19 is in contact with the screen 10;

FIG. 4 is an image-erasing device 18 according to an embodiment of the invention;

FIG. 5A is a physical appearance of an image-erasing device 18 according to an embodiment of the invention;

FIG. 5B is a top view illustrating an image-erasing device 18 according to an embodiment of the invention;

FIG. 6 shows a side view illustrating that the image-erasing device 18 is in contact with the screen 10;

FIG. 7A illustrates the erasing region according to the embodiment of FIG. 4;

FIG. 7B illustrates the erasing region according to the embodiment of FIG. 5A; and

FIG. 8 shows the operation of the image-erasing device on the screen according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. It is noted that, in accordance with the standard practice in the industry, various features are not drawn to scale. In fact, the dimensions of the various features may be arbitrarily increased or reduced for clarity of discussion. Furthermore, the reference numbers in the specification and the claim, such as “first”, “second”, the “third”, and so on, each other did not on the order of precedence relationship, which is only used to distinguish the different elements with the same name. In addition, the present invention may repeat reference numerals and/or letters in the various examples. This repetition is for the purpose of simplicity and clarity and does not in itself dictate a relationship between the various embodiments and/or configurations discussed.

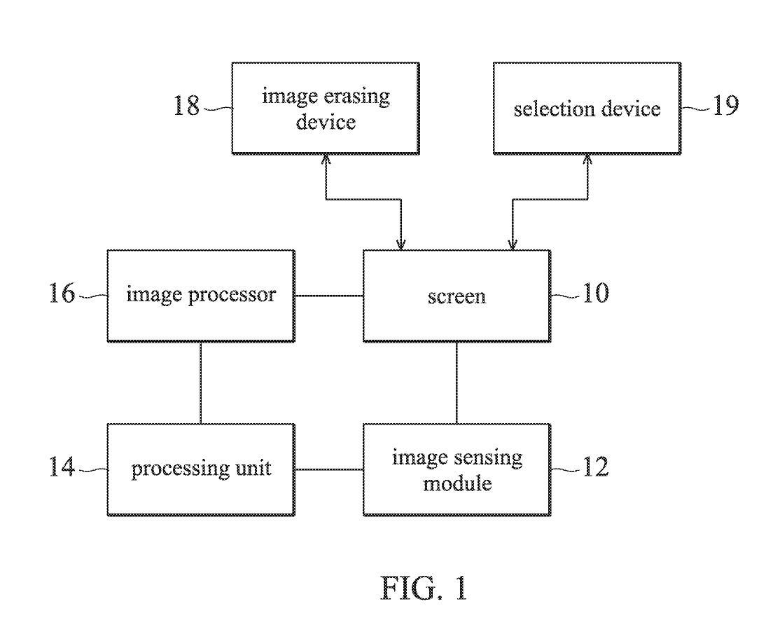

FIG. 1 is a block diagram of an optical touch system according to an embodiment of the invention. In FIG. 1, only the elements that are required to express the characteristics of the implementation of the invention are illustrated, the other elements, such as optical elements including lens, polarizers and refractors, bearing mechanism of the screen, and other accessories, are wholly conventional and will be fully appreciated by those with ordinary skill in the art, the detailed description of those is omitted here for sake of brevity.

As shown in FIG. 1, the optical touch system according to an embodiment of the invention includes a screen 10, an image-sensing module 12, a processing unit 14, an image processor 16, an image-erasing device 18 and a selection device 19. According to an embodiment of the invention, the screen 10 can be a flat panel display, such as a liquid-crystal display (LCD), a plasma display panel (PDP) display, an organic light-emitting diode (OLED) display, a field emission display (FED) and a light-emitting diode (LED) display. According to another embodiments, the screen 10 can be a projection screen or a predetermined region, such as a wall surface, that is able to display a projection image of a projector.

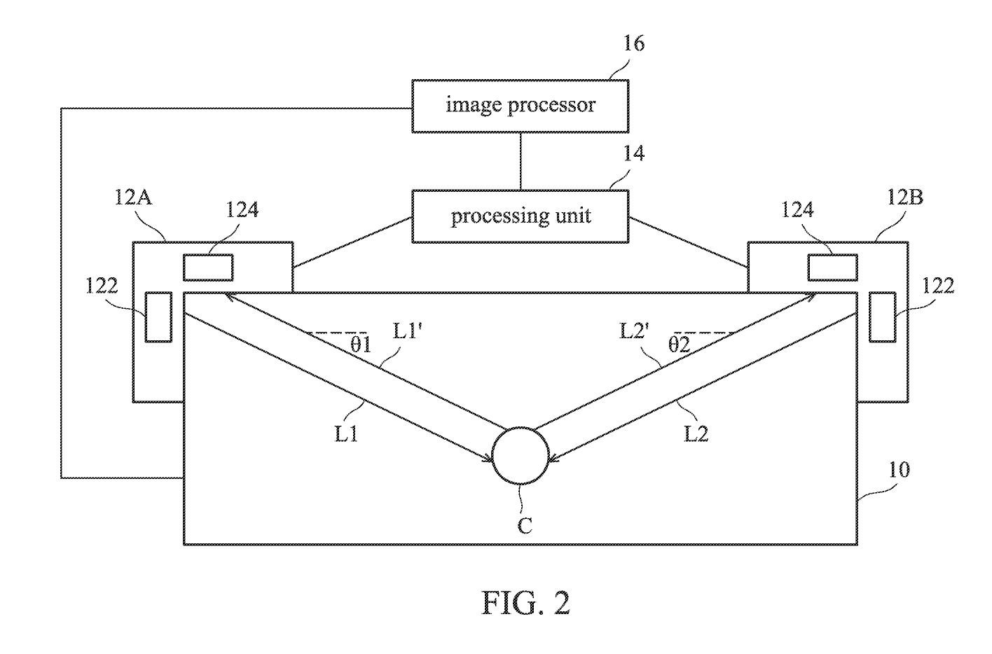

The image-sensing module 12 detects a position of a predetermined feature point on the screen 10. In an embodiment, a single image-sensing module 12 is able to detect the position of the predetermined feature point on the screen 10 by analyzing the position and depth information of the image of the feature point. In other embodiments, two image-sensing modules 12 are used to detect the position of the predetermined feature point on the screen 10. FIG. 2 illustrates the configuration of an optical touch system according to an embodiment of the invention. In FIG. 2, the image-sensing modules 12A and 12B are respectively disposed at the corners of the left top and right top of the screen 10. The image-sensing modules 12A and 12B may respectively include light sources 122 for emitting light beams L1 and L2. The optical paths of the light beams L1 and L2 are substantially parallel to the surface of the screen 10. In an embodiment, the light source 122 can be an infrared light emitter, and the light beams L1 and L2 are infrared beams. In addition, the image-sensing modules 12A and 12B may respectively include an image sensor 124. When the light beams L1 and L2 are reflected by the feature point, the reflected light beams L1′ and L2′ can be detected by the image sensor 124. In an embodiment, the image sensor 124 detects the angles of the reflected light beams L1′ and L2′, and when the image sensor 124 detects an infrared image, the detectable wavelength range is about 760 nm to 1 mm.

Returning to FIG. 1, when the image sensor 124 detects the angles of the reflected light beams L1′ and L2′, the detected information is transmitted to the processing unit 14. The processing unit 14 obtains the position of the feature point C corresponding to the screen 10 according to the angles θ1 and θ2 of the reflected light beams L1′ and L2′. The processing unit 14 may obtain the position of the feature point C using two-point-form according to the angles θ1 and θ2 of the reflected light beams L1′ and L2′. In another embodiment, three image-sensing modules 12 can be used to obtain the position of the feature point C. When using three image-sensing modules 12 to detect the position of the feature point C, more accurate positioning results can be obtained by a triangulation technique. The position of the feature point C is obtained using two-point-form or a triangulation technique, and is wholly conventional and will be fully appreciated by those with ordinary skill in the art, the detailed technical description is omitted here for sake of brevity. In addition, in FIG. 1, the processing unit 14 is separated from the image-sensing modules 12. However, the invention is not intended to be limited. The processing unit 14 can be integrated with one of the image-sensing modules 12, or integrated with each of the image-sensing modules 12.

The image processor 16 outputs an image to be displayed on the screen 10, or adjusts the image displayed on the screen 10 according to the control signals of the processing unit 14. As mentioned, the image can be projected to the screen 10 using light beams. In another embodiment, as the screen 10 is a flat panel display, the image processor 16 outputs image data corresponding to the type of flat panel display to the flat panel display for displaying the image.

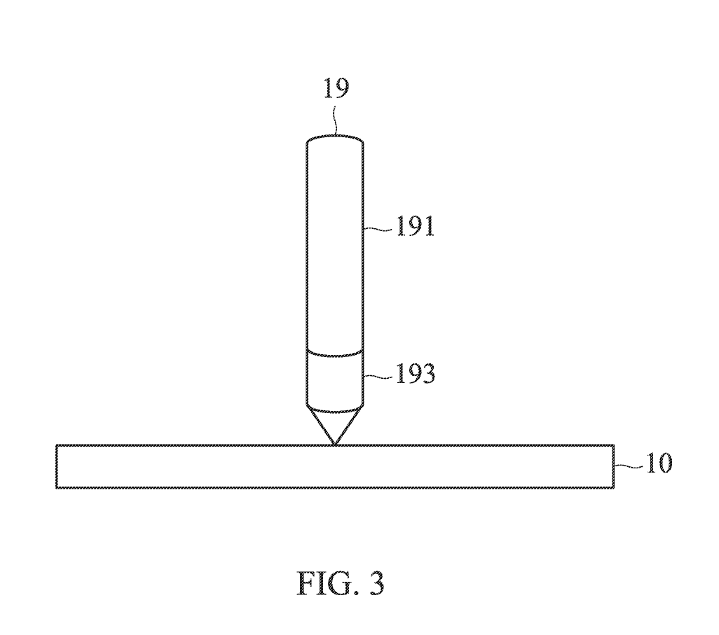

FIG. 3 shows a side view illustrating that the selection device 19 is in contact with the screen 10. The selection device 19 is detachably contacted with the screen 10. As shown in FIG. 3, the selection device 19 includes a body 191 and a reflection portion 193. In an embodiment, the selection device 19 can be a stylus. The reflection portion 193 can be formed by a retroreflector, which reflects incident light in its incident direction. Therefore, as shown in FIG. 2, when the light beams L1 and L2 are emitted to the feature point C with the retroreflector, the light beams L1′ and L2′ are reflected to the image sensor 124 through the incident paths of the light beams L1 and L2. In addition, the reflection portion 193 can be always exposed out of the body 191. In another embodiment, the reflection portion 193 can be exposed out of the body 191 when the body 191 is in contact with the screen 10 by a specific mechanism. Therefore, the light beams L1 and L2 are reflected while the body 191 is in contact with the screen 10 to detect the contact position. Those skilled in the art should realize the implementation of the specific mechanism for exposing the reflection portion 193, and the detailed structure of the specific mechanism is omitted here for sake of brevity.

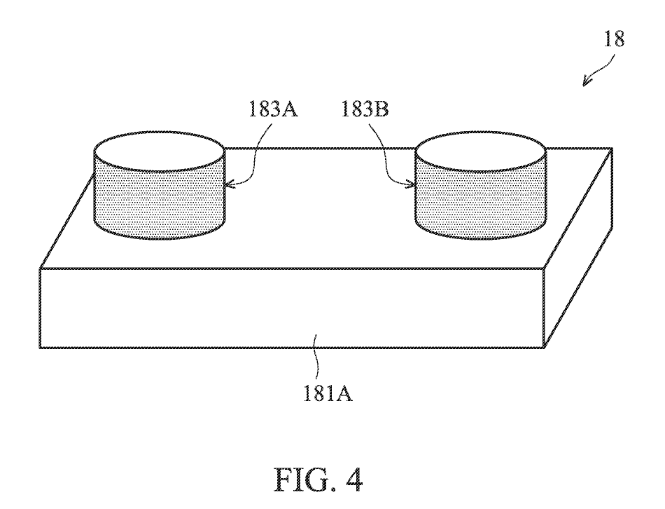

FIG. 4 is an image-erasing device 18 according to an embodiment of the invention. The image-erasing device 18 is detachably contacted with the screen 10. As shown, the image-erasing device 18 includes a body 181A, and reflection portions 183A and 183B. In this embodiment, the image-erasing device 18 can be a physical whiteboard eraser. Thus, the body 181A can be a rectangular structure, like the structure of a physical whiteboard eraser. However, the invention is not intended to be limiting. The body 181A may have an arbitrary shape based on actual requirements. Similarly, the reflection portions 183A and 183B can be formed by a retroreflector, which reflects incident light in its incident direction. In an embodiment, the reflection portions 183A and 183B can be a prism structure, such as a cylinder or a cuboid. In another embodiment, the reflection portions 183A and 183B can be a thin slice covering or setting in the side surface of a prism structure, respectively. Thus, the reflection portions 183A and 183B may be directly installed on the body 181A or on a prism structure of the body 181A. The bottom surface of the prism structure in contact with the screen 10 can be equipped with a buffer material which will not scratch the screen 10 or increase the friction force, such as cloth or another soft material. The friction force provided by the buffer material simulates the actual situation of using an eraser, to improve the user experience. In addition, the reflection portions 183A and 183B can always be exposed out of the prism structure. In another embodiment, the reflection portions 183A and 183B can be exposed out of the prism structure when the prism structure is in contact with the screen 10 by a specific mechanism. Therefore, the light beams are reflected while the prism structure is in contact with the screen 10 to detect the contact position. Those skilled in the art should realize the implementation of the specific mechanism for exposing the reflection portions 183A and 183B, and the detailed structure of the specific mechanism is omitted here for sake of brevity.

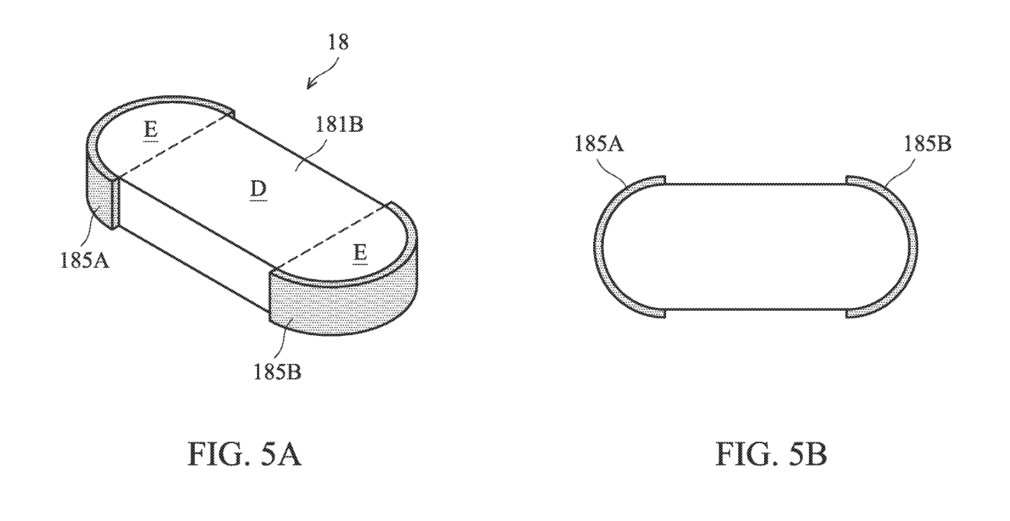

FIG. 5A is a physical appearance of an image-erasing device 18 according to an embodiment of the invention. As shown, the image-erasing device 18 includes a body 181B, and reflection portions 185A and 185B. In this embodiment, the image-erasing device 18 can be a physical whiteboard eraser. Thus, the body 181B can be a rectangular structure, like the structure of a physical whiteboard eraser. In this embodiment, the bottom or top surface of the body 181B may include a rectangular region D and two bow regions E on the opposite side of the rectangular region D. In this embodiment, the bottom surface of the body 181B of the image-erasing device 18 is in contact with the surface of the screen 10. The bottom surface of the body 181B can be equipped with a buffer material which will not scratch the screen 10 or increase the friction force, such as cloth or another soft material. The friction force provided by the buffer material simulates the actual situation of using an eraser, to improve the user experience. Similarly, the reflection portions 185A and 185B can be formed by a retroreflector, and are located at the side surface of the body 181B corresponding to the bow regions E, as shown in FIG. 5B. According to the embodiment, the positions of the reflection portions 185A and 185B are designed to be detected by the image sensor 124 even if the body 181B is rotated 360 degrees.

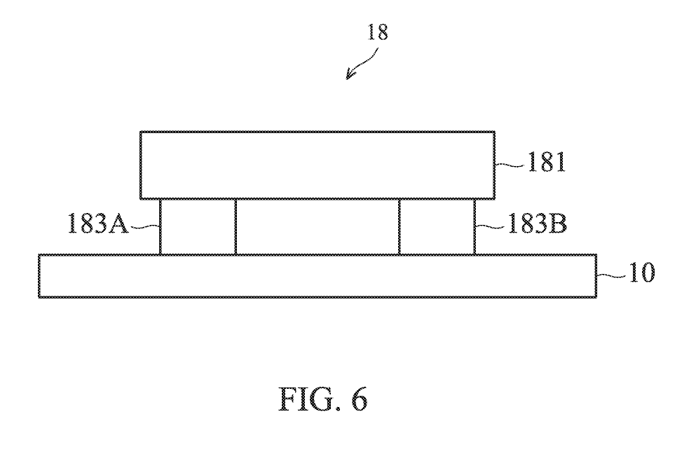

FIG. 6 shows a side view illustrating that the image-erasing device 18 is in contact with the screen 10. Using the image-erasing device 18 shown in FIG. 4 as an example, when the image-erasing device 18 is in contacted with the screen 10, the reflection portions 183A and 183B are approaching the surface of the screen 10. Therefore, the light beams emitted from the light sources 122 are reflected to the image sensor 124, the image sensor 124 transmits the information of the reflected light beams to the processing unit 14, and the processing unit 14 obtains the positions of the reflection portions 183A and 183B corresponding to the screen 10 according to the angles of the reflected light beams.

Returning to FIG. 1, when the processing unit 14 obtains the positions of the reflection portions corresponding to the screen 10, the processing unit 14 determines the number of reflection portions. As only a single reflection portion is detected, the single reflection portion is determined to be belonging to the selection device 19. Thus, the processing unit 14 executes a selection or input process according to the position of the reflection portion of the selection device 19. The selection process may comprise the selection of an image object of a user interface on the screen 10 corresponding to the position. The input process may comprise input text or a drawing on the screen 10 corresponding to the position. In addition, the processing unit 14 provides the position of the reflection portion of the selection device 19 as input position information to the image processor 16, and the image processor 16 displays a visual effect corresponding to the selection or input processes on the screen 10 based on the input position information.

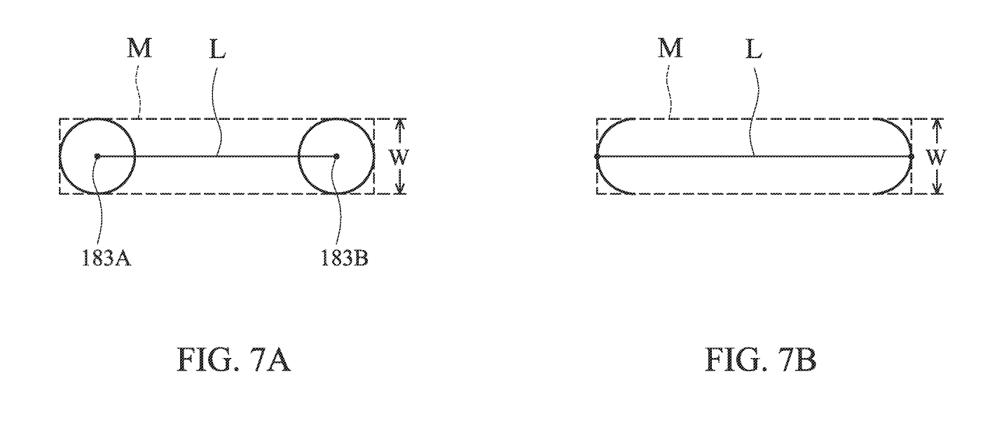

As a plurality of reflection portions are detected, the reflection portions are determined to be belonging to the image-erasing device 18. Thus, the processing unit 14 defines position information of a rectangular erasing region according to the reflection portions of the image-erasing device 18. FIG. 7A illustrates the erasing region according to the embodiment of FIG. 4. In the embodiment of the image-erasing device 18 of FIG. 4, the processing unit 14 sets the positions of the reflection portions 183A and 183B as the terminals of a line L, and expands a predetermined width W along a direction that is orthogonal to the line L. The predetermined width W can be determined according to a preset width of a erasing region M, or according to the profiles of the reflection portions 183A and 183B. Thus, the width of the erasing region M is determined. The length of the erasing region M can be determined according to the length of the line L, or further adjusted according to the profiles of the reflection portions 183A and 183B. In the embodiment of FIG. 7A, the length of the erasing region M is extended according to the profiles of the reflection portions 183A and 183B.

FIG. 7B illustrates the erasing region according to the embodiment of FIG. 5A. In the embodiment of the image-erasing device 18 of FIG. 5A, the processing unit 14 sets the positions of the reflection portions 185A and 185B as the terminals of a line L, and expands a predetermined width W along a direction that is orthogonal to the line L. The predetermined width W can be determined according to a preset width of a erasing region M, or according to the profiles of the reflection portions 183A and 183B. Thus, the width of the erasing region M is determined. The length of the erasing region M can be determined according to the length of the line L. Note that the profile of the erasing region M can be a rectangle, or adjusted according to the profiles of the reflection portions. In addition, the profile of the erasing region M can be also defined by system designers. For example, system designers may define a rectangular erasing region M. As the positions of the reflection portions 185A and 185B corresponding to the screen 10 are identified, the position of the erasing region M can be determined according to those of the reflection portions 185A and 185B. Thus, as the position of the erasing region M having a predetermined profile is determined according to the positions of a plurality of feature points, it does not depart from the spirit and scope of the invention.

When the position information of the erasing region M is defined, the processing unit 14 provides the position information of the erasing region M to the image processor 16, and the image processor 16 erases the image data in the region on the screen 10 corresponding to the position information of the erasing region M according to the position information of the erasing region M, to obtain the effect of image erasing using the image-erasing device 18.

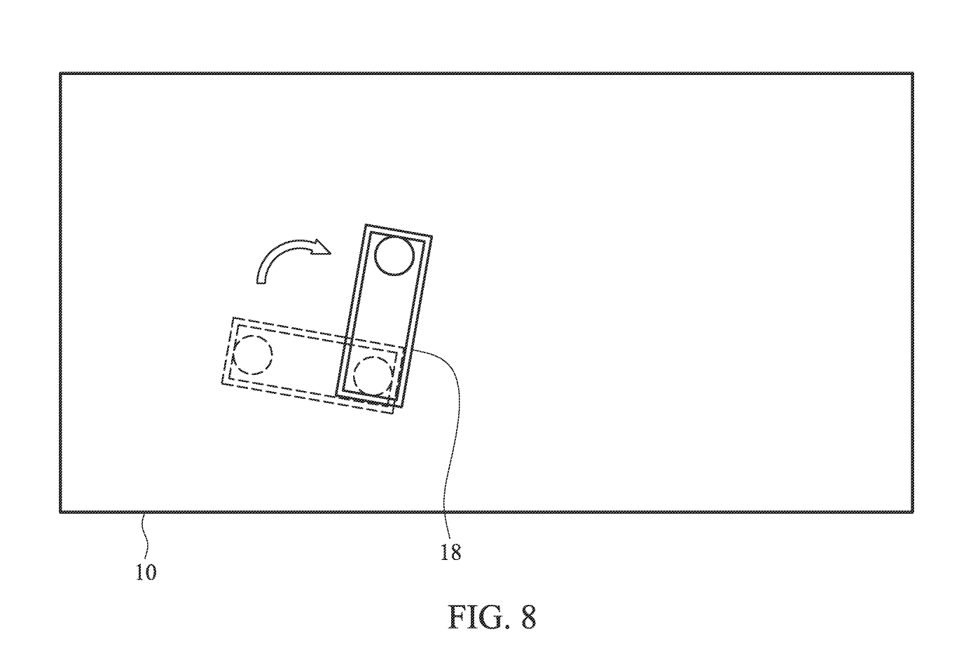

According to the embodiments of the invention, because the erasing region of the image-erasing device is rectangular, the effect of image erasing is similar to the physical eraser. As shown in FIG. 8, when the user uses the image-erasing device 18 according to the embodiments of the invention to erase an image, the erasing region can be controlled by rotating the image-erasing device 18, increasing the efficiency of image erasing. In addition, the embodiments of the invention switch the input and erasing processes according to the number of detected feature points, and the users can selectively use the input and erasing functions without selecting the image objects of the user interface, increasing the efficiency of using the optical touch systems.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present invention.

What is claimed is:

1. An optical touch system, comprising:
a screen;
an image-erasing device comprising a body and a plurality of reflection portions on the body, wherein the image-erasing device is detachably contacted with the screen;
at least one image-sensing module adjacent to the screen, comprising:
a light source emitting a light beam to the reflection portions to generate a reflected light beam corresponding to the reflection portions; and
an image sensor detecting the reflected light beams;
a processing unit obtaining a plurality of positions on the screen respectively corresponding to the reflection portions according to the reflected light beams, and defining position information of an erasing region according to the positions on the screen respectively corresponding to the reflection portions; and
an image processor outputting a display image to be displayed on the screen, and erasing data of the display image corresponding to the erasing region according to the position information.

2. The optical touch system of claim 1, wherein the number of reflection portions is two, and the processing unit defines the erasing region according to the positions of the two reflection portions.

3. The optical touch system of claim 2, wherein the erasing region is rectangular, a length of the erasing region is determined according to a distance between the two reflection portions, and a width of the erasing region is determined according to profiles of the reflection portions.

4. The optical touch system of claim 1, wherein the reflection portions are prism structures installed at both terminals of the body, and the image-erasing device is in contact with the screen by the reflection portions.

5. The optical touch system of claim 1, wherein the body comprises a bottom surface in contact with the screen, and a side surface adjacent to the bottom surface, and the reflection portions are installed separately on the side surface.

6. An optical touch system, comprising:
a screen;
a selection device comprising a first reflection portion;
an image-erasing device comprising a body and a plurality of second reflection portions on the body, wherein the selection device and the image-erasing device are detachably contacted with the screen;
at least one image-sensing module adjacent to the screen, comprising:
a light source emitting a light beam to the first reflection portion or the second reflection portions to generate reflected light beams corresponding to the first reflection portion or the second reflection portions; and
an image sensor detecting the reflected light beams;
a processing unit obtaining a first position on the screen corresponding to the first reflection portion or a plurality of second positions on the screen respectively corresponding to the second reflection portions according to the reflected light beams, obtaining input position information according to the first position and executing a selection or input process according to the input position information when the first reflection portion is detected, to the second positions when the second reflection portions are detected; and
an image processor outputting a display image to be displayed on the screen, displaying a visual effect corresponding to the selection or input process on the screen according to the input position information, and erasing data of the display image corresponding to the erasing region according to the erasing position information.

7. The optical touch system of claim 6, wherein the number of second reflection portions is two, and the processing unit defines the erasing region according to the positions of the two second reflection portions.

8. The optical touch system of claim 7, wherein the erasing region is rectangular, a length of the erasing region is determined according to a distance between the two second reflection portions, and a width of the erasing region is determined according to profiles of the second reflection portions.

9. The optical touch system of claim 6, wherein the second reflection portions are prism structures installed at both terminals of the body, and the image-erasing device is in contact with the screen by the second reflection portions.

10. The optical touch system of claim 6, wherein the body comprises a bottom surface in contact with the screen, and a side surface adjacent to the bottom surface, and the second reflection portions are installed separately on the side surface.
